(19) United States
(12) Patent Application Publication
(10) Pub. No.: US 2019/0339857 A1
(43) Pub. Date: Nov. 7, 2019

(54) TYPING SYSTEM AND METHOD OF USE

(71) Applicant: Huadong Chen, Dallas, TX (US)

(72) Inventor: Huadong Chen, Dallas, TX (US)

(21) Appl. No.: 16/230,213

(22) Filed: Dec. 21, 2018

Related U.S. Application Data
(60) Provisional application No. 62/665,190, filed on May 1, 2018.

(51) Int. Cl. G06F 3/0488; G06F 3/041

(52) U.S. Cl. CPC G06F 3/04886; G06F 2203/04104; G06F 3/0416

(57) ABSTRACT

A typing system that allows multiple points to be monitored by an input device like a touchpad and translated into characters or words. Multiple points on each hand or other appendage enable a vast array of movements, touches or other activity that allow for rapid character entry.

### BACKGROUND

### 1. Field of the Invention

The present invention relates generally to input systems, and more specifically, to a typing system for forming words by an action of the hands or other appendages with a computing device without the use of a keyboard.

### 2. Description of Related Art

Input systems are well known in the art and are effective means to allow a person to provide data to a computer. For example, conventional keyboards allow a person to press buttons or keys to select letters that then form words or commands that are stored or acted upon by a computer. Commonly, keyboards have an individual key for each letter, numeral and other marks or functions. Additionally, alternative data may be received from a key when pressed in conjunction with another key.

One of the problems commonly associated with a conventional keyboard is its limited efficiency. For example, forming a word requires the number of keys pressed to be equal to greater than the number of the letters in the word, while those skilled in the art are able to rapidly press keys with few errors, they are limited by the required number key presses.

Additionally, the keyboard must be marked for the language they are intended for and cannot be efficiently remarked or used between languages, causing duplication and waste.

Accordingly, although great strides have been made in the area of keyboards, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a side view of a typing system in accordance with a preferred embodiment of the present application;

FIG. 2 is a top view of the contemplated input regions of the system of FIG. 1;

FIG. 3 is a top view of the input map of the system of FIG. 1;

FIG. 4 is a top view of the movement patterns of FIG. 3;

FIG. 5 is a diagram of the input device of the system of FIG. 1; and

FIG. 6 is a flowchart of the preferred method of use of the system of FIG. 1.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional keyboards. Specifically, the invention of the present application allows for infinite motion combination to be used to increase the input of characters or words in a computing device. In addition, the invention allows for the use of a single input device with any language without reprinting or marking. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

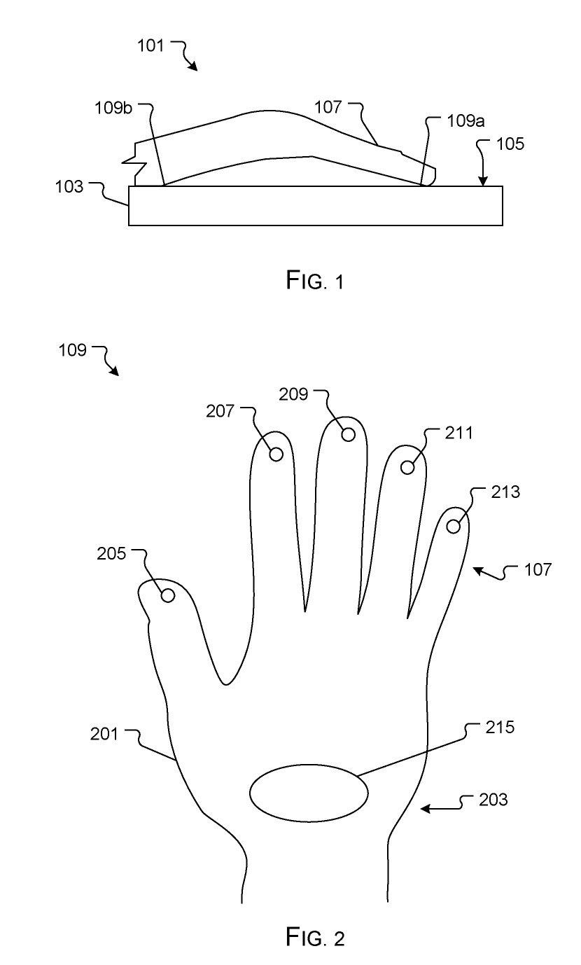

Referring now to the drawings wherein like reference characters identify corresponding or similar elements throughout the several views, FIG. 1 depicts a side view of a typing system in accordance with a preferred embodiment of the present application. It will be appreciated that system 101 overcomes one or more of the above-listed problems commonly associated with conventional keyboards.

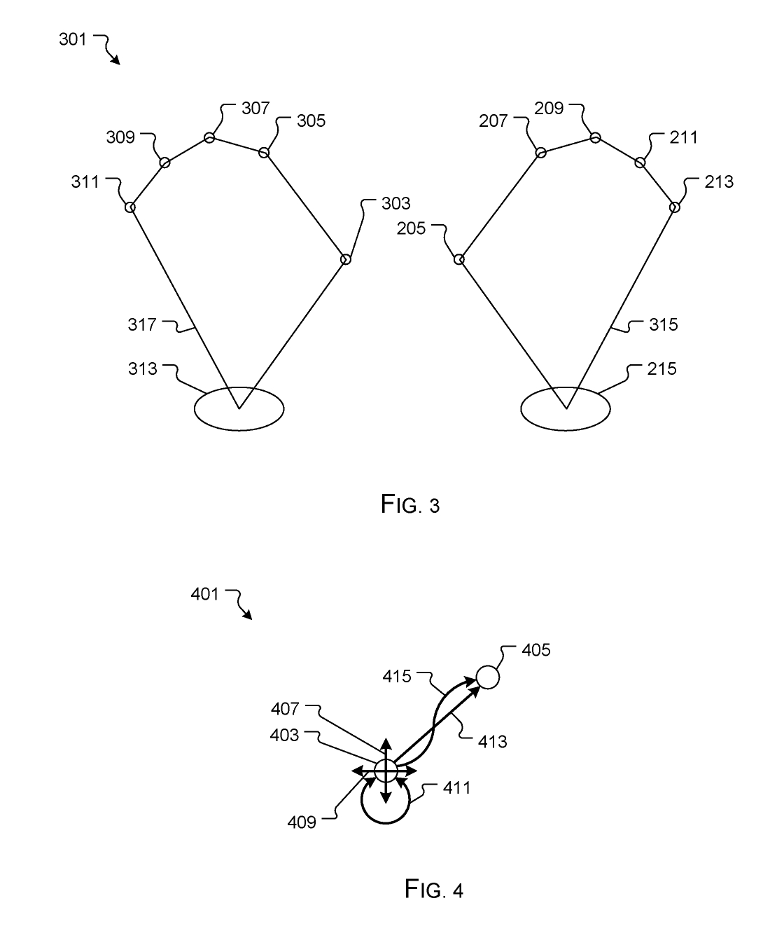

In the contemplated embodiment, system 101 includes an input device 103 in physical communication via the top surface 105 with a finger 107. The junction of a finger 107 or other part of the hand with the surface creates contact points 109. It is contemplated that the contact points would be created by a hand 201 as depicted by FIG. 2, where each finger 107 has an individual contact point 205, 207, 209, 211, 213 and that another contact point 215 would be the base of the palm 203. While these contact points 205, 207, 209, 211, 213, 215 are contemplated any number or manner of creating tactile contact with input device 103 could be used.

In the preferred embodiment the input device 101 monitors the activity of the contact points 205, 207, 209, 211, 213, 215 and their relationship to each other. Referring now to FIG. 3 they system 101 includes both hands adding contact points 303, 305, 307, 309, 311 and 313 with contact points 205, 207, 209, 211, 213, 215. It is contemplated that each hand is represented by a construct 315 for the right hand and 317 for the left hand. These constructs 315, 317 capture data about the corresponding contact points and translate the data to input.

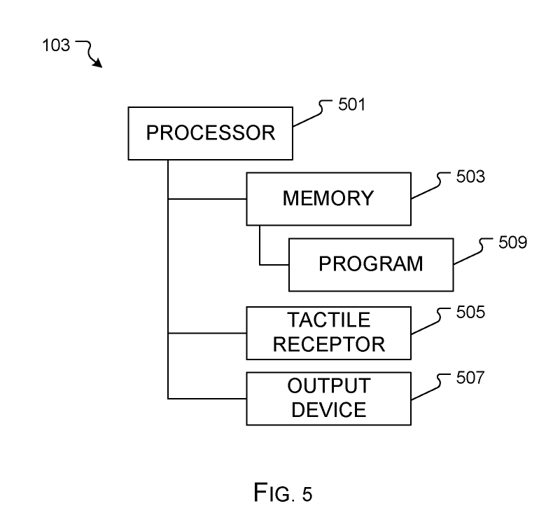

It is contemplated each contact point 205, 207, 209, 211, 213, 215, 303, 305, 307, 309, 311, 313 could have many movements or patterns captured by the input device 103. Examples of these patterns are depicted in FIG. 4. Movements 401 include lateral translation 409 at location 403, forward-reverse translation 407, circular translation 411 or the relocation of the contact point to location 405 a direct path 413 or an indirect path 415. Other motions are possible and could be used within the system 101, such as tapping, holding, simultaneous actions from multiple contact points.

It is further contemplated that the data from the input device could be interpreted in a standard or customized manner such as an individual altering a movement to indicate a special or unique data input.

It should be appreciated that one of the unique features believed characteristic of the present application is the number of combinations available to indicate a specific action such as inputting a letter, word or phrase with minimal action or effort.

It should also It will be appreciated that other believed advantages of the system 101 include one or more of the following features: (1) no keyboard or keyboard configuration is required for input; (2) the user does not need to observe where they type on the keyboard or other conventional input devices; (3) the system 101 is highly flexible and customizable—it is configured to be personalized for each individual user; and (4) it provides particular benefit to those with impaired sight or handicapped people that have trouble with reading or locating the keyboard. These and other features are contemplated in the preferred embodiment.

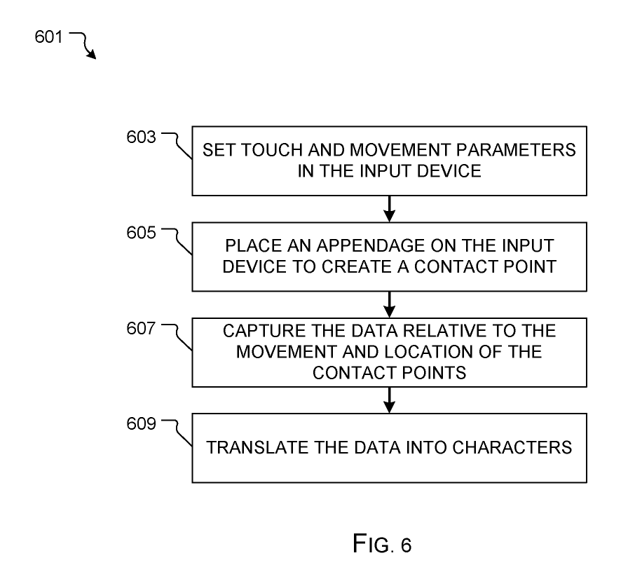

Referring now to FIG. 5 the input device of system 101 is depicted. Device 103 including a processor 501 in communication with memory 503, a tactile receptor 505 and output port 507 configured to send the data from the input device 103 to another computing device. It is further contemplated that the memory 503 stores and enables a program 509 that accepts and translates the data from the constructs 315, 317 and their respective movements.

It will be understood and appreciated that the consistent structure of the human hand, that is the positions and the relative positions of the contact points follow a geometric pattern as defined by construct 315, 317. The geometric patterns includes: contact points 303 through 313 are located on the left side of the input device 103; contact points 205 through 215 are located on the right side of the screen; contact points 303 through 311 and 205 through 213 are located on the top of the input device 103; contact points 313 and 215 are located on the bottom of the input device 103. Thus, the distance between points 311 to 313 are roughly 1.5 times the distance between points 303 to 313 (similar on the right hand). The distance between points 303 to 313 is roughly 2 times the distance between points 303 to 305 (similar on the right hand). The distance between points 303 to 305 are roughly 2 times the distance between points 311 to 309, or points 309 to 307, or points 307 to 305 (similar on the right hand). The distances between any 2 points on the left hand are relatively consistent (similar on the right hand). These features are shown in FIG. 3 of the drawings. Based on these two-dimensional geometric patterns, the software easily detects the contact points' identities.

It should be understood that there are altogether 12 contact points. Each of them capable of being independently clicked or touched to represent a character. For example, each corresponds to the most-frequently-used characters E, A, R, I, O, T, N, S, L, C, U, D. (Or E, A, R, I, O, space, T, N, S, L, C, space if space is included).

For the rest of the characters, the following non-single-click methods are representative: (1) Combinations of simultaneous double clicks, E.g., clicking 305 and 303 simultaneously output letter P, clicking 305 and 307 simultaneously output letter M, etc.; (2) Combination of simultaneous multiple clicks (more than 2 clicks), E.g., clicking 307, 309 and 311 simultaneously output letter H, clicking 305, 307, 309 and 311 simultaneously output letter G, and clicking 303, 305, 307, 309 and 311 simultaneously output letter Z or select all; (3) Duration of clicks—If the input device 103 detects a click that lasts over 1 second it interprets it as a capital letter; (4) Intensity of clicks—If the input device 103 detects a click that has a high intensity it interprets it as a bold letter; (5) Sequence of clicks—If the input device 103 detects multiple clicks that are in a sequence closely together it interprets it as a special character. E.g., clicking sequentially 303, 307 and 309 output character “©”; and gesture of the clicks—If the input device 103 detects a click that has a certain gesture it interprets it as a certain character. E.g., clicking 303 and swiping to the left output character “1”. Clicking 303 and swiping to the right output character “2”. Clicking 303 and swiping up output character “3”. Clicking 303 and swiping down output character “4”. Clicking 303 and swiping circularly clockwise output character “!”. Clicking 303 and swiping circularly counterclockwise output character “&”.

In the preferred embodiment, the system 101 involves dual hands. But it could be reduced to a single hand or be increased to multiple hands (more than 2), still working based on the same methodology.

It is contemplated that machine learning training that automatically generates the best clicking-to-output correspondence for each user could be implemented with the system 101. For example, the user places their fingers and hands on a touch screen and moves them. The machine learning training automatically relates the most typical clicks to the highest-frequency outputs.

Self-correction of misspells and word & sentence auto-completion can complement this typing system.

Referring now to FIG. 6 the preferred method of use of system 101 is depicted. Method 601 includes setting touch and movement parameters in the input device 603, placing an appendage on the input device to create contact points 605, capturing the data relative to the movement and location of the contact points 607 and translating the data into characters 609.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. A typing system comprising:
an input device in contact with an object where the meeting place between the two forms a contact point;
wherein at least one contact point is tracked and recorded by the input device and translated into at least one character.

2. The system of claim 1 wherein the contact points are created by two hands.

3. The method of entering characters given the system of claim 1 comprising:
setting touch and movement parameters in the input device;
placing an appendage on the input device to create contact points;
capturing the data relative to the movement and location of the contact points; and
translating the data into characters.
